(19) United States
(12) Patent Application Publication
(10) Pub. No.: US 2016/0378168 A1
(43) Pub. Date: Dec. 29, 2016

(54) DYNAMIC POWER MANAGEMENT OPTIMIZATION

(71) Applicant: Advanced Micro Devices, Inc., Sunnyvale, CA (US)

(72) Inventors: Alexander J. Branover, Chestnut Hill, MA (US); Ashish Jain, Austin, TX (US); Sridhar V. Gada, Bangalore (IN)

(21) Appl. No.: 14/751,515

(22) Filed: Jun. 26, 2015

(51) Int. Cl. G06F 1/32

(52) U.S. Cl. CPC G06F 1/3287; G06F 1/3296

(57) ABSTRACT

Systems, apparatuses, and methods for managing power usage of integrated circuits. One or more processor cores may be powered down when the system is idle. Even if there is no user activity, the processor core(s) may be woken up periodically for background downloads to retrieve the latest status for social media and other applications. Additionally, a power management unit may track the average number of active cores and the average core utilization. If the average number of active cores is less than a first threshold and the average core utilization is less than a second threshold, the power management unit may generate a request to offline one or more cores. Still further, when the processor's skin temperature is above a threshold and all of the cores are operating at the lowest acceptable operating point, one or more cores may be powered down.

### BACKGROUND

Technical Field

Embodiments described herein relate to integrated circuits and more particularly, to managing power consumption of integrated circuits.

Description of the Related Art

Managing power consumption in integrated circuits (ICs) such as computer system processors and various types of system-on-a-chip (SoC) ICs is increasingly important. This is true not only during times when an IC is actively performing work, but also during times when the IC is idle. In particular, the small feature sizes of transistors in ICs can result in leakage currents and thus power consumption even in functional units that are otherwise not performing any work.

When a functional unit of an IC becomes idle, power management hardware or software may take various actions to reduce power consumption. Reducing clock frequencies or gating clocks may reduce dynamic power consumption. Reducing a supply voltage may provide additional reductions in power consumption. In some cases, a functional unit may be power gated (i.e., may have power removed therefrom) when it is idle. This may be referred to as a deep sleep state.

Entry into a low power or sleep state may be accomplished by performing various actions. Consider for example an SoC having multiple processor cores and a power management unit implemented thereon. Actions performed in placing a processor core into a sleep state may include flushing any caches that will lose power, turning off power from phase locked loops (PLLs), saving system states, and so forth. Upon entry into the low power or sleep state, the processor core may remain there until an external interrupt or other action that causes initiation of a wake-up of the core.

In addition to power consumption, performance is another factor that must be considered in designing computers and other types of processor-based electronic systems. Generally speaking, higher performance results in a higher amount of power consumed. Conversely, limiting the amount of power consumed limits the potential performance of a computer or other type of processor-based electronic system. Achieving the maximum performance per unit of power consumed (power/watt) is a key metric in the design of processor-based systems. This is particularly true in portable, battery powered systems, where minimizing power consumption is critical.

### SUMMARY

Systems, apparatuses, and methods for managing the power consumption of integrated circuits are contemplated.

In one embodiment, a power management unit on an integrated circuit may determine whether or not measured activity of any of a plurality of compute units exceeds one or more thresholds. For example, in one embodiment, a processor (e.g., a CPU) of the integrated circuit may be idle, but software may periodically wake the CPU up to check for any background downloads or other activity that may need attention. In various embodiments, the background downloads may be for social media applications (e.g., Facebook, Twitter, LinkedIn), new emails, and so on. By periodically waking up and performing the background downloads, this ensures that the user will see the updated status the next time the user starts using the host device (e.g., smartphone, tablet). When the CPU wakes up, if the CPU determines that there is not much work to be done, then the wake-up interval can be increased. As long as the CPU keeps waking up and determines there is less than a threshold amount of work to do, then the wake-up interval can keep increasing. In some embodiments, the power management unit may track measured activity, wherein the measured activity includes one or more of memory accesses, input/output (I/O) accesses, instructions executed, and/or one or more other factors. In one embodiment, the measured activity may be monitored using one or more counters to maintain a moving average of the measured activity. If the measured activity is less than a first threshold, then the duration of a wake-up timer may be increased, wherein the wake-up timer determines how long to keep a compute unit asleep when the compute unit is powered down. If the measured activity is greater than a second threshold, then the wake-up timer may be decreased.

In another embodiment, a power management unit of a multi-core processor may monitor the average number of active cores and the average core utilization. The power management unit may make decisions to force cores offline or to power-up offline cores based at least in part on the status of the average number of active cores and the average core utilization. In one embodiment, if the average number of active cores is below a first threshold and the average core utilization is below a second threshold, then the power management unit may generate a request to power down one or more cores. If the average core utilization is above a third threshold, then the power management unit may power up one or more offline cores and return the core(s) to the scheduler pool.

These and other features and advantages will become apparent to those of ordinary skill in the art in view of the following detailed descriptions of the approaches presented herein.

### BRIEF DESCRIPTION OF THE DRAWINGS

The above and further advantages of the methods and mechanisms may be better understood by referring to the following description in conjunction with the accompanying drawings, in which:

FIG. 1 is a block diagram of one embodiment of an integrated circuit (IC) coupled to a memory.

FIG. 2 is a block diagram of one embodiment of a prediction unit and a power management unit.

FIG. 3 illustrates a graph of average core utilization in accordance with one embodiment.

FIG. 4 is a generalized flow diagram illustrating one embodiment of a method for dynamically adjusting the wake-up timer for a SOC.

FIG. 5 is a generalized flow diagram illustrating one embodiment of a method for setting the length of the wake-up timer based on the time of day.

FIG. 6 is a generalized flow diagram illustrating another embodiment of a method for setting the length of the wake-up timer based on the time of day.

FIG. 7 is a generalized flow diagram illustrating one embodiment of a method for implementing a power-saving mode for a multi-core processor.

FIG. 8 is a generalized flow diagram illustrating another embodiment of a method for implementing a power-saving mode for a multi-core processor.

### DETAILED DESCRIPTION OF EMBODIMENTS

In the following description, numerous specific details are set forth to provide a thorough understanding of the methods and mechanisms presented herein. However, one having ordinary skill in the art should recognize that the various embodiments may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

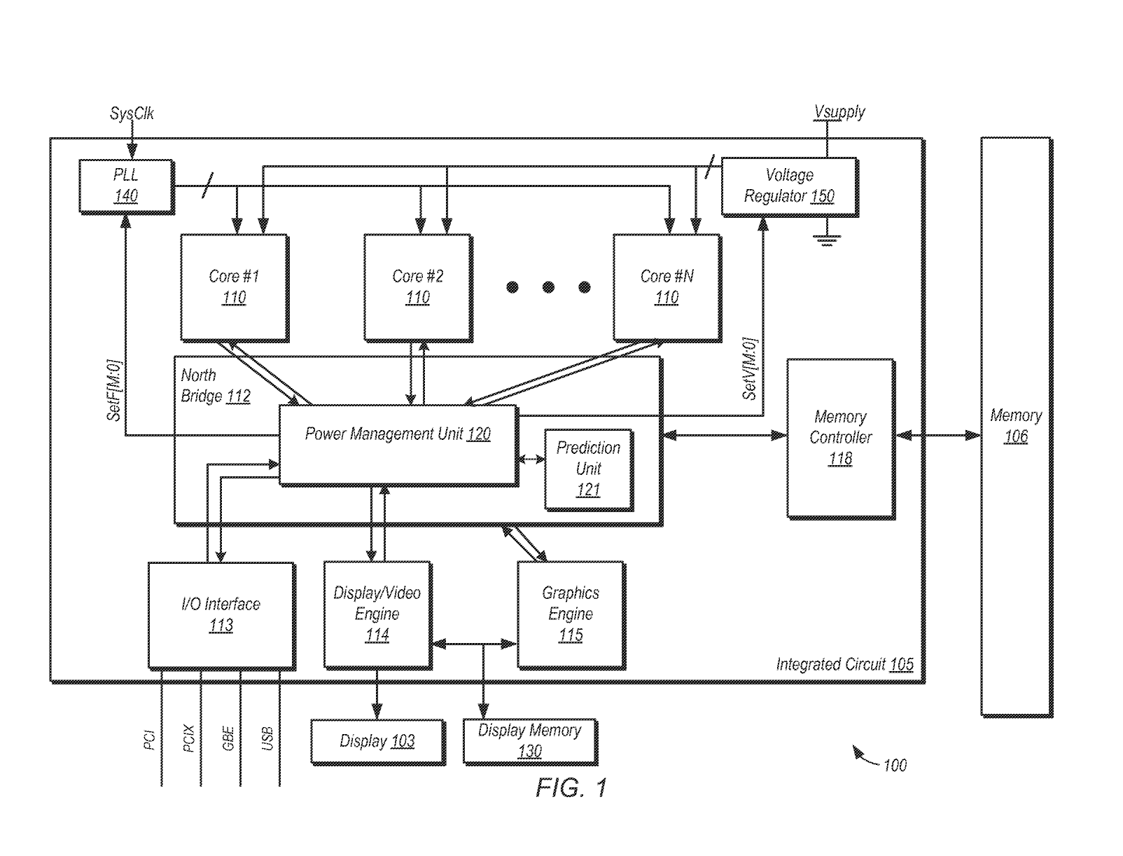

Referring now to FIG. 1, a block diagram of one embodiment of an integrated circuit (IC) 105 coupled to a memory 106 is shown. IC 105 and memory 106, along with display 103 and display memory 130, form at least a portion of computer system 100 in this example. In the embodiment shown, IC 105 is a system-on-a-chip (SOC) having a number of processing nodes 110. Processing nodes 110 are processor cores in this particular example, and are thus also designated as Core #1, Core #2, and so forth. It is noted that the methodology to be described herein may be applied to other arrangements, such as multi-processor computer systems implementing multiple processors (which may be single-core or multi-core processors) on separate, unique IC dies. Furthermore, embodiments having only a single processing node 110 are also possible and contemplated.

Each processing node 110 is coupled to north bridge 112 in the embodiment shown. North bridge 112 may provide a wide variety of interface functions for each of processing nodes 110, including interfaces to memory and to various peripherals. In addition, north bridge 112 includes a power management unit 120 that is configured to manage the power consumption of each of processing nodes 110. It is noted that power management unit 120 may be implemented in a location external to north bridge 112 in some embodiments. The power management functions performed by power management unit 120 may include the determination of whether to enter various low power states based at least in part on the recent and historical activity level of processing nodes 110. For example, power management unit 120 may reduce the supply voltage and/or reduce the frequency of a clock signal provided to a processing node 110. Power management unit 120 may place a processing node 110 into a sleep state by gating (i.e., turning off) both the clock signal and the power provided thereto. Power management unit 120 may provide various signals to a processing node 110 prior to gating power and clock signals provided thereto in order to enable it to perform actions such as flushing caches, saving states, and so forth.

In the embodiment shown, north bridge 112 includes a prediction unit 121 coupled to power management unit 120. Prediction unit 121 is configured to store and analyze information related to the recent activity levels for each of the processor cores 110, and may also store information related to the history of activity. Using the predictions made by prediction unit 121, power management unit 120 may determine whether and for how long to place a processor core 110 into a low power state. A low power state as defined herein may be a state in which a voltage supplied to processor core is reduced from its maximum, a state in which the frequency of the clock signal is reduced, a state in which the clock signal is inhibited from a processor core (clock-gated), one in which power is removed from a processor core (power-gated), or a combination of any of the former. A low power state in which both clock and power are removed from a processor core may be referred to as a sleep state.

Since there is overhead in entering a low power state in terms of energy costs and performance costs, power management unit 120 may use the prediction to determine the optimal amount of time to spend in a low power state to avoid repetitive and wasteful switching between power states. For example, entry into a sleep state may require flushing of one or more caches, saving a processor state, powering down PLLs, and so on. Upon exit from a sleep state, PLLs may require a warm-up period before fully operating. Restoration of a previous state may also be required upon exit from a sleep state. Cache misses may also occur frequently upon re-commencing operations following the exit from a sleep state. Accordingly, entry into a sleep state (and more generally, entry into a low power state) incurs various costs.

In various embodiments, power management unit 120 may put a given core 110 to sleep responsive to detecting one or more conditions. The duration of time for how long the given core 110 is put to sleep may vary according to one or more detected conditions. In one embodiment, power management unit 120 may utilize a wake-up timer to determine how long to put the given core 110 to sleep. Power management unit 120 may set the duration of the wake-up timer based on a variety of factors, including recent core activity, historical core activity, current time of day, current day of the week, and/or other factors.

For example, power management unit 120 may put a given core 110 to sleep for a relatively short duration during the day while power management unit 120 may put the given core 110 to sleep for a relatively long duration during the night. In one embodiment, the daytime may be determined based on a set schedule regardless of individual user of system 100. In another embodiment, the daytime hours may be determined based on a history of user activity, such that a first user may have a different schedule from a more traditional second user. For example, a first user may work at night and be more likely to check social media (e.g., Facebook, Twitter, Linkedln) or other websites during nighttime hours. Accordingly, the first user may be more likely to be active and receive updates at night than the second user. Therefore, the nighttime hours may be considered a period of high activity for the first user and be the equivalent of “daytime” as experienced by the second user.

In one embodiment, if the current time is during the daytime or a period of high activity, then power management unit 120 may set the wake-up timer of one or more cores 110 or the entire IC 105 to a first duration. If the current time is during the nighttime or a period of low activity then power management unit 120 may set the wake-up timer to a second duration, wherein the second duration is longer than the first duration. For example, in one embodiment, the second duration may be set to a value equal to the first duration multiplied by a first factor (e.g., 10), wherein the first factor is a positive integer greater than one. In another embodiment, the first factor may be proportional to the amount of recent and/or historical activity for the current time of day.

In various embodiments, power management unit 120 may track user activity over a period of time. Power management unit 120 may plot the user activity versus times of day and days of the week to determine if any patterns emerge. In some embodiments, power management unit 120 may determine the usual wake-up time for the user of system 100 based on the history of tracked activity. Power management unit 120 may then decrease the duration of the wake-up timer when the current time of day is within a threshold amount of time of the usual wake-up time.

In various embodiments, the number of processing nodes 110 may be as few as one, or may be as many as feasible for implementation on an IC die. In multi-core embodiments, processing nodes 110 may be identical to each other (i.e., homogenous multi-core), or one or more processing nodes 110 may be different from others (i.e., heterogeneous multi-core). Processing nodes 110 may each include one or more execution units, cache memories, schedulers, branch prediction circuits, and so forth. Furthermore, each of processing nodes 110 may be configured to assert requests for access to memory 106, which may function as the main memory for computer system 100. Such requests may include read requests and/or write requests, and may be initially received from a respective processing node 110 by north bridge 112. Requests for access to memory 106 may be routed through memory controller 118 in the embodiment shown.

I/O interface 113 is also coupled to north bridge 112 in the embodiment shown. I/O interface 113 may function as a south bridge device in computer system 100. A number of different types of peripheral buses may be coupled to I/O interface 113. In this particular example, the bus types include a peripheral component interconnect (PCI) bus, a PCI-Extended (PCI-X), a PCIE (PCI Express) bus, a gigabit Ethernet (GBE) bus, and a universal serial bus (USB). However, these bus types are exemplary, and many other bus types may also be coupled to I/O interface 113. Peripheral devices may be coupled to some or all of the peripheral buses. Such peripheral devices include (but are not limited to) keyboards, mice, printers, scanners, joysticks or other types of game controllers, media recording devices, external storage devices, network interface cards, and so forth. At least some of the peripheral devices that may be coupled to I/O interface 113 via a corresponding peripheral bus may assert memory access requests using direct memory access (DMA). These requests (which may include read and write requests) may be conveyed to north bridge 112 via I/O interface 113, and may be routed to memory controller 118.

In the embodiment shown, IC 105 includes a display/video engine 114 that is coupled to display 103 of computer system 100. Display 103 may be a flat-panel LCD (liquid crystal display), plasma display, a CRT (cathode ray tube), or any other suitable display type. Display/video engine 114 may perform various video processing functions and provide the processed information to display 103 for output as visual information. Some video processing functions, such as 3-D processing, processing for video games, and more complex types of graphics processing may be performed by graphics engine 115, with the processed information being relayed to display/video engine 114 via north bridge 112.

In this particular example, computer system 100 implements a non-unified memory architecture (NUMA) implementation, wherein video memory and RAM are separate from each other. In the embodiment shown, computer system 100 includes a display memory 130 coupled to display/video engine 114. Thus, instead of receiving video data from memory 106, video data may be accessed by display/video engine 114 from display memory 130. This may in turn allow for greater memory access bandwidth for each of cores 110 and any peripheral devices coupled to I/O interface 113 via one of the peripheral buses.

In the embodiment shown, IC 105 includes a phase-locked loop (PLL) unit 140 coupled to receive a system clock signal. PLL unit 140 may include a number of PLLs configured to generate and distribute corresponding clock signals to each of processing nodes 110. In this embodiment, the clock signals received by each of processing nodes 110 are independent of one another. Furthermore, PLL unit 140 in this embodiment is configured to individually control and alter the frequency of each of the clock signals provided to respective ones of processing nodes 110 independently of one another. The frequency of the clock signal received by any given one of processing nodes 110 may be increased or decreased in accordance with performance demands imposed thereupon. The various frequencies at which clock signals may be output from PLL unit 140 may correspond to different operating points for each of processing nodes 110. Accordingly, a change of operating point for a particular one of processing nodes 110 may be put into effect by changing the frequency of its respectively received clock signal.

In the case where changing the respective operating points of one or more processing nodes 110 includes the changing of one or more respective clock frequencies, power management unit 120 may change the state of digital signals SetF[M:0] provided to PLL unit 140. Responsive to the change in these signals, PLL unit 140 may change the clock frequency of the affected processing node(s). Additionally, power management unit 120 may also cause PLL unit 140 to inhibit a respective clock signal from being provided to a corresponding one of processing nodes 110.

In the embodiment shown, IC 105 also includes voltage regulator 150. In other embodiments, voltage regulator 150 may be implemented separately from IC 105. Voltage regulator 150 may provide a supply voltage to each of processing nodes 110. In some embodiments, voltage regulator 150 may provide a supply voltage that is variable according to a particular operating point (e.g., increased for greater performance, decreased for greater power savings). In some embodiments, each of processing nodes 110 may share a voltage plane. Thus, each processing node 110 in such an embodiment operates at the same voltage as the other ones of processing nodes 110. In another embodiment, voltage planes are not shared, and thus the supply voltage received by each processing node 110 may be set and adjusted independently of the respective supply voltages received by other ones of processing nodes 110. Thus, operating point adjustments that include adjustments of a supply voltage may be selectively applied to each processing node 110 independently of the others in embodiments having non-shared voltage planes. In the case where changing the operating point includes changing an operating voltage for one or more processing nodes 110, power management unit 120 may change the state of digital signals SetV[M:0] provided to voltage regulator 150. Responsive to the change in the signals SetV[M:0], voltage regulator 150 may adjust the supply voltage provided to the affected ones of processing nodes 110. In instances in power is to be removed from (i.e., gated) one of processing nodes 110, power management unit 120 may set the state of corresponding ones of the SetV[M:0] signals to cause voltage regulator 150 to provide no power to the affected processing node 110.

It should be noted that embodiments are possible and contemplated wherein the various units discussed above are implemented on separate IC's. For example, one embodiment is contemplated wherein cores 110 are implemented on a first IC, north bridge 112 and memory controller 118 are on another IC, while the remaining functional units are on yet another IC. In general, the functional units discussed above may be implemented on as many or as few different ICs as desired, as well as on a single IC. It is further noted that while the discussion above has focused on a particular embodiment of an SoC, the various methodologies described herein may be used with any IC that implements power management functions.

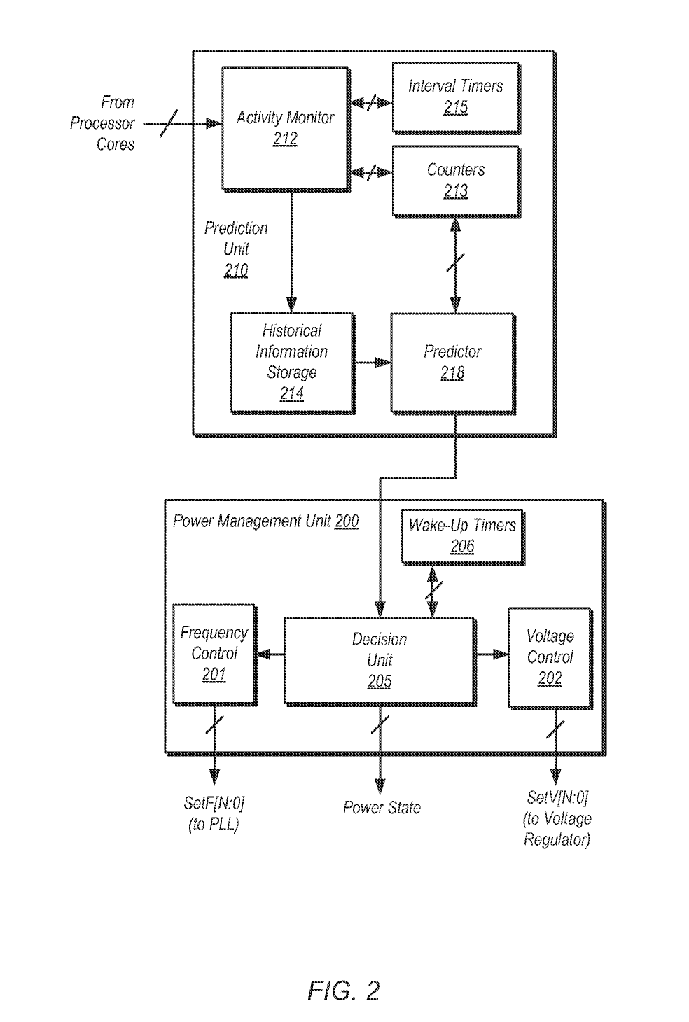

Turning now to FIG. 2, a block diagram illustrating one embodiment of a prediction unit 210 and an embodiment of a power management unit 200 is shown. In the embodiment shown, prediction unit 210 includes an activity monitor 212 coupled to receive indications of activity from various processor cores (not shown). In a more generalized embodiment, activity monitor 212 may be coupled to receive activity indications from various different types of functional units implemented on an IC. Returning to this particular embodiment, the types of activity monitored by activity monitor 212 may include (but are not limited to) memory accesses, I/O accesses, instructions executed, and so on.

Prediction unit 210 in the embodiment shown includes a plurality of interval timers 215 (shown here as a single block encompassing each of the timers). One interval timer 215 may be included for each of the functional blocks for which activity is to be monitored. During an interval, if activity is detected for a given processor core, then a corresponding counter 213 may be incremented. If no activity is detected for the given processor core during the interval, then the corresponding counter 213 may be decremented. Accordingly, each counter 213 may maintain a moving average of detected activity for a corresponding processor core.

Activity monitor 212 may store historical activity information for each core in historical information storage 214. The historical activity information may include information regarding activity during different times of the day. For example, the historical activity information may include how much activity has been historically detected during each hour of the day. Additionally, the historical activity information may include how much activity has been detected for a given hour and given day of the week.

Predictor 218 is coupled to historical information storage 214. Based on the data stored in historical information storage 214, predictor 218 may generate a duration to be utilized for the next sleep state for a given processor core or for the entire SOC. Various methodologies may be used to generate the prediction, and these methodologies are discussed in further detail below. For example, in one embodiment, predictor 218 may generate a duration of the next sleep state that is dependent on the historical activity for that particular time of day. If the current time falls during the nighttime, and historical activity during nighttime indicates a likelihood of low activity, then predictor 218 may generate a relatively long duration for the next sleep state. If the current time falls within a threshold amount of time of morning, and historical activity during early morning hours indicates an increase in activity is predicted to occur, then predictor 218 may generate a relatively short duration for the next sleep state.

In some cases, predictor 218 may also generate durations for the length of the next sleep state based at least in part on the value of counters 213. For example, if the current time falls during the nighttime, and historical activity during nighttime indicates a likelihood of low activity, but the counter 213 for a given processor core indicates a high level of recent activity, predictor 218 may generate a relatively short duration for the next sleep state.

In one embodiment, when a processor core is placed in a sleep state, power management unit 200 may cause that core to exit the sleep state at a predetermined time when a corresponding wake-up timer 206 expires. This exit from the sleep state may be invoked without any other external event (e.g., an interrupt from a peripheral device) that would otherwise cause an exit from the sleep state.

Predictions made by predictor 218 may be forwarded to decision unit 205 of power management unit 200. Responsive to determining which power state a processor core is to be placed, decision unit 205 may provide power state information (Tower State') to that core. A processor core receiving updated power state information from decision unit 205 may perform various actions associated with entering the updated power state (e.g., a state save in the event that the updated power state information indicates that the processor core will be entering the sleep state).

Power management unit 200 in the embodiment shown includes a frequency control unit 201 and a voltage control unit 202. Frequency control unit 201 is configured to generate control signals for adjusting the frequency of the clock signals provided to each of the processor cores. The frequency of a clock signal provided to a given one of processor cores may be adjusted independently of the clock signals provided to the other cores. The frequency control signals may be provided to a corresponding PLL unit (not shown). In addition to changing the frequency of a clock signal, frequency control signals may also cause the PLL unit to inhibit a clock signal (clock gate') from being provided to a selected one of processor cores. Voltage control unit 202 in the embodiment shown is configured to generate control signals provided to voltage regulators (not shown) for independently adjusting the respective supply voltages received by each of the processor cores. Voltage control signals may be used to reduce a supply voltage provided to a given processor core, increase a supply voltage provided to that core, or to turn off that core by inhibiting it from receiving any supply voltage. Both frequency control unit 201 and voltage control unit 202 may generate their respective control signals based on information provided to them by decision unit 205.

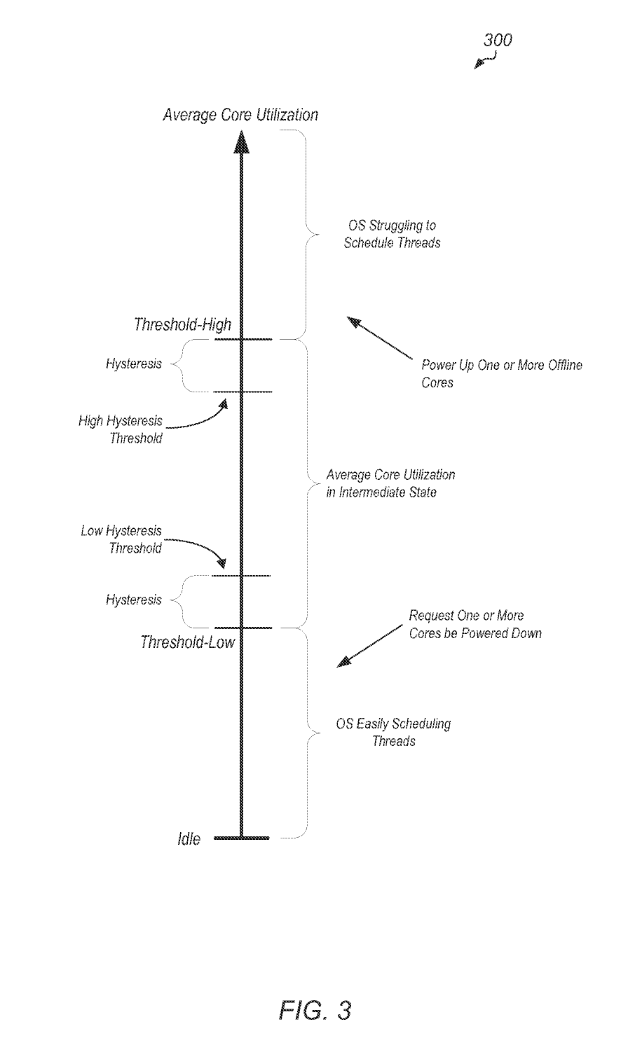

Referring now to FIG. 3, a graph 300 of average core utilization is shown. In the example shown, the graph 300 of average core utilization is divided into three main regions: the region between ‘Idle’ and the low threshold, the region between the low threshold and the high threshold, and the region above the high threshold. In one embodiment, the term “core utilization” may be defined as the percent of time that a core is in the highest performance state. In another embodiment, the term “core utilization” may be defined as the percentage of time when the core is executing instructions, transferring data, responding to interrupts, or is otherwise busy (i.e., not idle). The term “average core utilization” may be defined as the average of the core utilization values for all cores of a multi-core processor.

An average core utilization level in the first region (i.e., less than the low threshold) indicates that the operating system (OS) is not struggling to schedule threads on the available cores. Accordingly, if the average core utilization level is less than the low threshold, then the power management unit may generate a request to power down one or more cores.

An average core utilization level in the third region (i.e., above the high threshold) indicates that the OS is struggling to schedule threads on the available cores. If one or more cores are currently offline (i.e., powered down), then the power management unit may bring these offline cores back online in response to determining the average core utilization level is above the high threshold.

When the average core utilization level is detected in the second region (above the low threshold but less than the high threshold), the number of offline cores may remain unchanged. Alternatively, when the average core utilization level is detected in the second region, the power management unit may let the OS select the number of cores to keep in an offline state.

In addition to the high and low thresholds shown in FIG. 3, hysteresis threshold levels may also be considered when determining whether or not to adjust the number of offline cores. A high hysteresis threshold may be considered when determining whether to power up one or more cores, while a low hysteresis threshold may be considered when determining whether to whether to power down one or more cores. Utilizing these hysteresis thresholds may prevent the number of online cores from being changed due to an anomaly. The operations described above may enhance the efficiency of a processor by improving its performance per watt of power consumed. For example, increasing the number of offline cores when the average core utilization is below the low threshold may decrease power consumption without negatively affecting the performance of the processor.

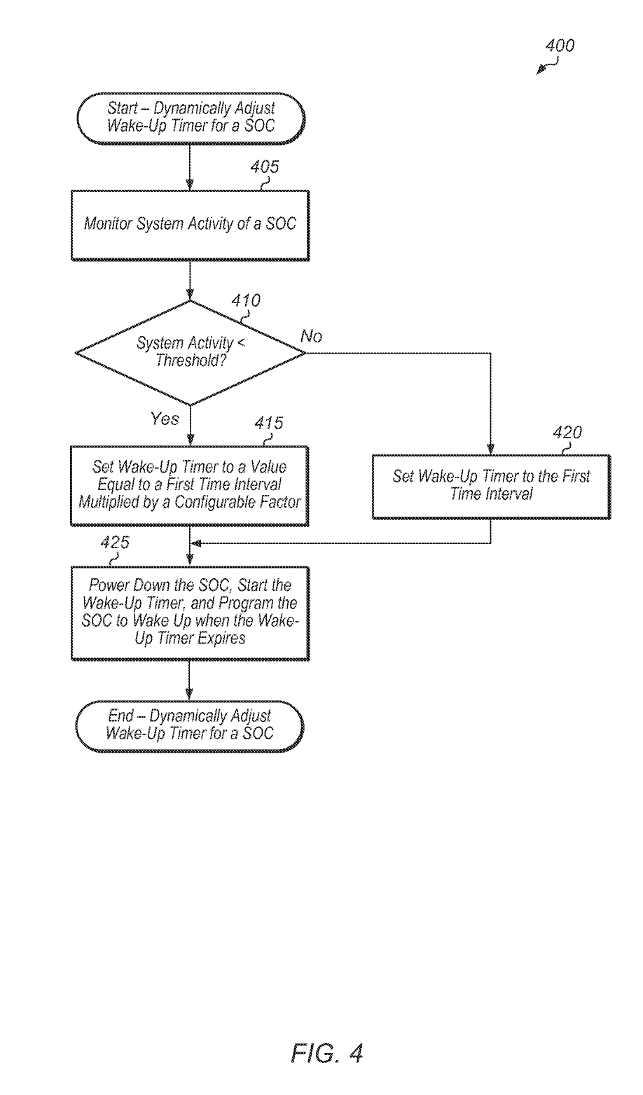

Turning now to FIG. 4, one embodiment of a method 400 for dynamically adjusting the wake-up timer for a SOC is shown. For purposes of discussion, the steps in this embodiment are shown in sequential order. It should be noted that in various embodiments of the method described below, one or more of the elements described may be performed concurrently, in a different order than shown, or may be omitted entirely. Other additional elements may also be performed as desired. Any of the various devices, apparatuses, or systems described herein may be configured to implement method 400.

A power management unit may monitor system activity of a SOC (block 405). In one embodiment, the power management unit may utilize one or more counters to measure the monitored system activity, and the monitored system activity may include memory accesses, I/O accesses, instructions executed, and/or one or more other factors. In one embodiment, the counters may maintain moving averages of different types of system activity. Next, the power management unit may determine to power down the SOC (block 410). Depending on the embodiment, the decision to power down the SOC may be based on the idleness of the SOC. If the SOC is idle for some time, the SOC may be powered down. Otherwise, if there is activity on the SOC, the SoC may be kept on. Next, the power management unit may determine if the system activity has fallen below a threshold (conditional block 410). In one embodiment, the term “system activity” may refer to activity during the last cycle when the SOC was woken up by the periodic timer. Additionally, system activity may refer to background activity rather than user-driven activity, user-driven activity, or any combination of background and user-driven activity. All such embodiments are contemplated.

If the system activity has fallen below a threshold (conditional block 410, “yes” leg), then the power management unit may set a wake-up timer to a value equal to a first time interval multiplied by a factor (block 415). The wake-up timer may determine the amount of time the SOC is kept in sleep mode when the SOC is put to sleep. In one embodiment, the factor may be adjusted based on the time of day, such that during nighttime, the factor may be increased as compared to during the daytime. For example, in one embodiment, the factor may be 5 during the day and 100 during the night. In another embodiment, the factor may increase the longer the system activity is below the threshold. For example, the factor may be 5 for a first sleep interval, then 10 for a second sleep interval, then 15, then 20, and so on, with the factor increasing for as long as the system activity is below the threshold. Once the system activity is detected above the threshold, the factor may be reset back to its original value. In other embodiments, the factor may be adjusted based on both recent system activity and historical system activity. If the system activity is above the threshold (conditional block 410, “no” leg), then the power management unit may set the wake-up timer to the first time interval (block 420). After blocks 415 and 420, the power management unit may power down the SOC, start the wake-up timer, and program the SOC to wake up when the wake-up timer expires (block 425). After block 425, method 400 may end.

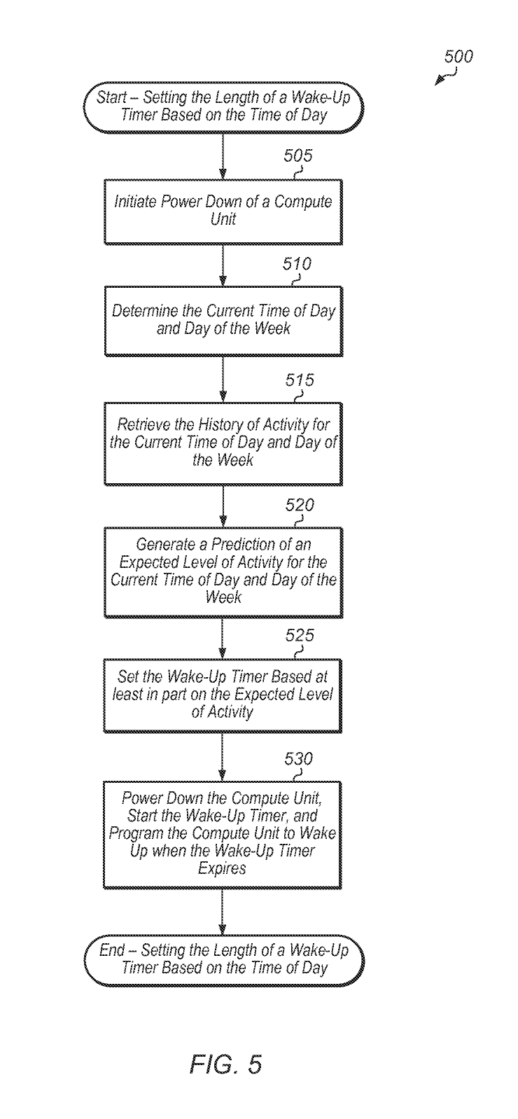

Turning now to FIG. 5, one embodiment of a method 500 for setting the length of the wake-up timer based on the time of day is shown. For purposes of discussion, the steps in this embodiment are shown in sequential order. It should be noted that in various embodiments of the method described below, one or more of the elements described may be performed concurrently, in a different order than shown, or may be omitted entirely. Other additional elements may also be performed as desired. Any of the various devices, apparatuses, or systems described herein may be configured to implement method 500.

A power management unit may initiate power down of a compute unit (block 505). In one embodiment, the compute unit may be one or more cores of a processor or SOC. In another embodiment, the compute unit may be one or more processing units (e.g., shaders or otherwise) of a graphics processor. In a further embodiment, the compute unit may be an entire multi-core processor, SOC, or other IC. These and other embodiments are possible and are contemplated. Next, the power management unit may determine the current time of day and day of the week (block 510). In one embodiment, this information may be maintained or stored locally. In another embodiment, the power management unit may retrieve this information from an external source.

Next, the power management unit may retrieve the history of activity for the current time and day of the week (block 515). The history of activity may be utilized by the power management unit to generate a prediction of an expected level of activity for the current time and day of the week (block 520). Next, the power management unit may set the wake-up timer based at least in part on the expected level of activity for the current time and day of the week (block 525). For example, if the expected level of activity is relatively low, the wake-up timer may be set to a relatively long interval, and if the expected level of activity is relatively high, the wake-up timer may be set to a relatively short interval. Next, the power management unit may power down the compute unit, start the wake-up timer, and program the compute unit to wake up when the wake-up timer expires (block 530). After block 530, method 500 may end.

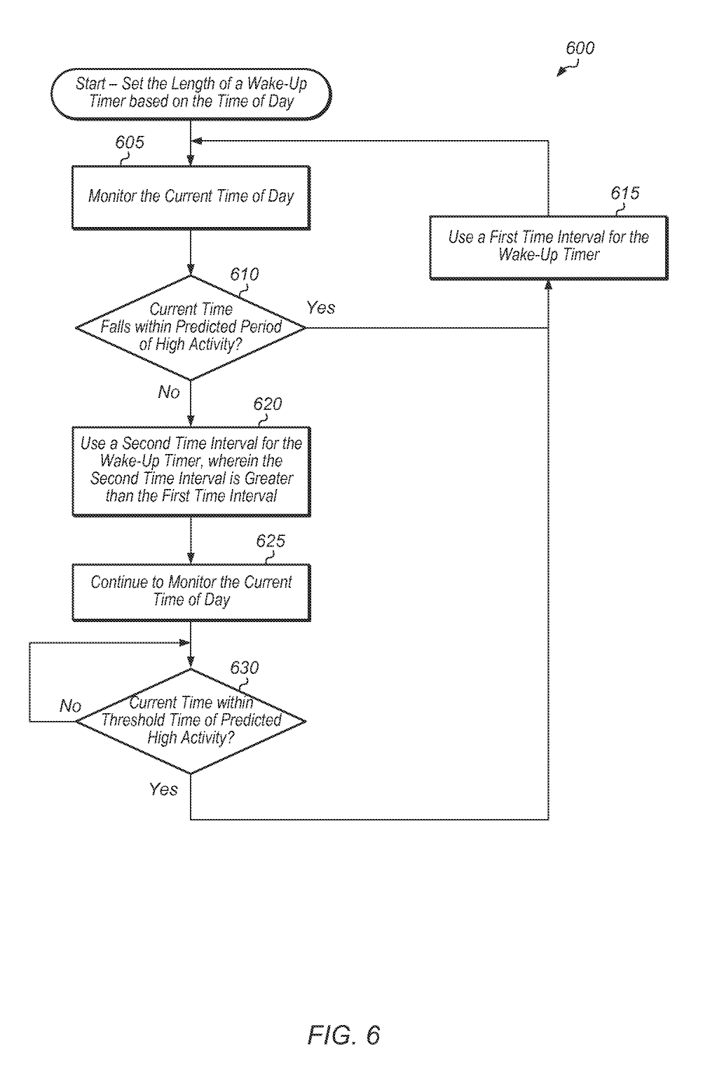

Turning now to FIG. 6, another embodiment of a method 600 for setting the length of the wake-up timer based on the time of day is shown. For purposes of discussion, the steps in this embodiment are shown in sequential order. It should be noted that in various embodiments of the method described below, one or more of the elements described may be performed concurrently, in a different order than shown, or may be omitted entirely. Other additional elements may also be performed as desired. Any of the various devices, apparatuses, or systems described herein may be configured to implement method 600.

A power management unit of an SOC may monitor the current time of day (block 605). The power management unit may determine if the current time of day falls within a predicted period of high activity based on the user's history (conditional block 610). If the current time of day falls within a predicted period of high activity (conditional block 610, “yes” leg), then the power management unit may use a first time interval for the wake-up timer (block 615). The next time the SOC is put to sleep, the wake-up timer may be utilized by the power management unit for determining how long the SOC is put to sleep. After block 615, method 600 may return to block 605 with the power management unit monitoring the current time of day. If the current time of day does not fall within a predicted period of high activity based on the user's history (conditional block 610, “no” leg), then the power management unit may use a second time interval for the wake-up timer, wherein the second timer interval is greater than the first time interval (block 620). In one embodiment, the second time interval may be the first time interval multiplied by a first factor, wherein the first factor may be a positive integer. For example, in one embodiment, the second time interval may be the first time interval multiplied by ten.

After block 620, the power management unit may continue to monitor the current time of day (block 625). The power management unit may determine if the current time of day is within a threshold amount of time of a predicted period of high activity (conditional block 630). For example, in one embodiment, the threshold amount of time may be thirty minutes. If the current time of day is within a threshold amount of time of a predicted period of high activity (conditional block 630, “yes” leg), then the power management unit may use the first time interval for the wake-up timer (block 615). If the current time of day is not within a threshold amount of time of a predicted period of high activity (conditional block 630, “no” leg), then method 600 may remain at conditional block 630.

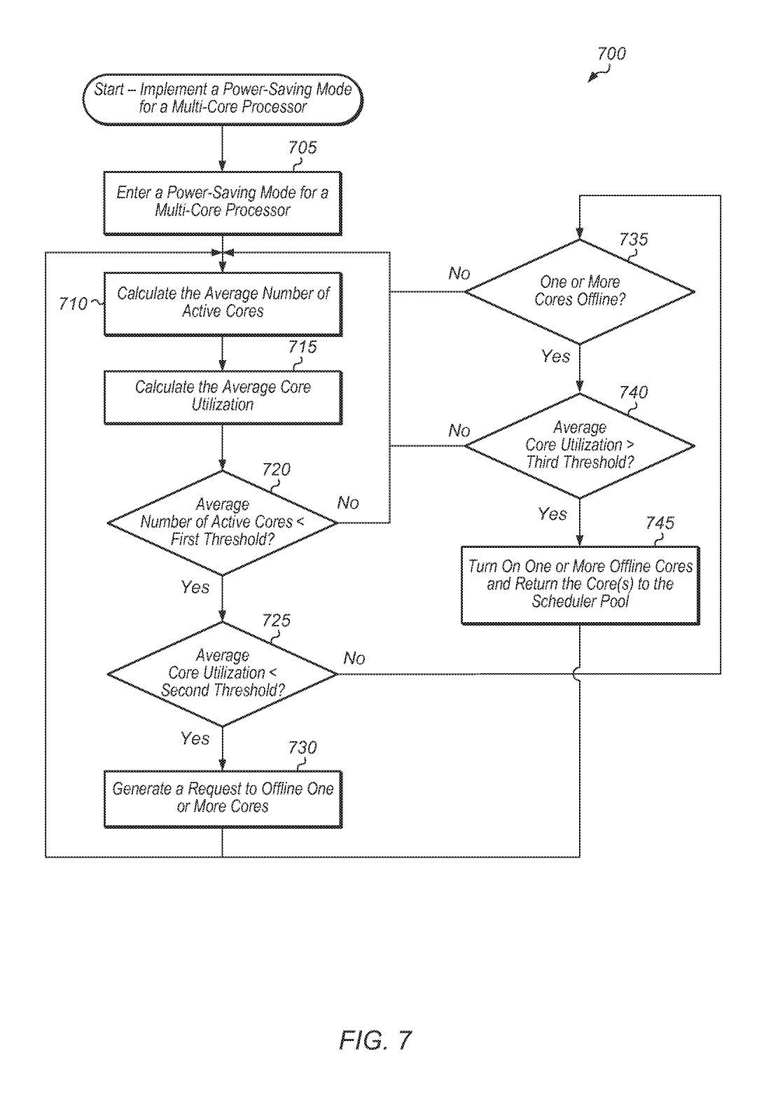

Referring now to FIG. 7, one embodiment of a method 700 for implementing a power-saving mode for a multi-core processor is shown. For purposes of discussion, the steps in this embodiment are shown in sequential order. It should be noted that in various embodiments of the method described below, one or more of the elements described may be performed concurrently, in a different order than shown, or may be omitted entirely. Other additional elements may also be performed as desired. Any of the various devices, apparatuses, or systems described herein may be configured to implement method 700.

A multi-core processor may enter a power-saving mode (block 705). In one embodiment, the multi-core processor may enter the power-saving mode in response to detecting the host system is running on battery power. In other embodiments, the multi-core processor may enter the power-saving mode in response to detecting other conditions. Depending on the embodiment, the processor may utilize a plurality of operating modes and the processor may transition between operating modes based on changes in the operating conditions.

Next, the power management unit may calculate the average number of active cores of the multi-core processor (block 710). In one embodiment, the power management unit may utilize a counter to maintain a moving average of the number of active cores. Also, the power management unit may calculate the average core utilization (block 715). In one embodiment, the power management unit may utilize a counter to track the average core utilization, which may be a moving average.

The power management unit may determine if the average number of active cores is less than a first threshold (conditional block 720). If the average number of active cores is less than a first threshold (conditional block 720, “yes” leg), then the power management unit may determine if the average core utilization is less than a second threshold (conditional block 725). In one embodiment, the power management unit may utilize a counter for each core to track the core utilization. The average core utilization may be the average of the utilization value for each core of the multi-core processor. If the average number of active cores is less than a first threshold (conditional block 720, “no” leg), then method 700 may return to block 710 with the power management unit tracking the average number of active cores.

If the average core utilization is less than the second threshold (conditional block 725, “yes” leg), then the power management unit may generate a request to offline one or more cores (block 730). If the average core utilization is less than the second threshold, this indicates that the operating system (OS) is not struggling to schedule threads on the active cores. After the request is generated, the OS will typically grant the request, and then one or more cores may be turned off and removed from the scheduler pool.

If the average core utilization is greater than the second threshold (conditional block 725, “no” leg), the power management unit may determine if there are one or more cores currently offline (conditional block 735). If there are one or more cores currently offline (conditional block 735, “yes” leg), then the power management unit may determine if the average core utilization is greater than a third threshold (conditional block 740). It may be assumed for the purposes of this discussion that the third threshold is greater than the second threshold. If all of the cores are currently online (conditional block 735, “no” leg), then method 700 may return to block 710 with the power management unit tracking the average number of active cores.

If the average core utilization is greater than the third threshold (conditional block 740, “yes” leg), then the power management unit may turn on one or more offline cores and return the core(s) to the scheduler pool (block 745). If the average core utilization is greater than the third threshold, this indicates that the OS is struggling to schedule threads on the cores, and therefore the OS would benefit from having one or more additional cores added to the scheduler pool. If the average core utilization is less than the third threshold (conditional block 740, “no” leg), then method 700 may return to block 710 with the power management unit continuing to track the average number of active cores.

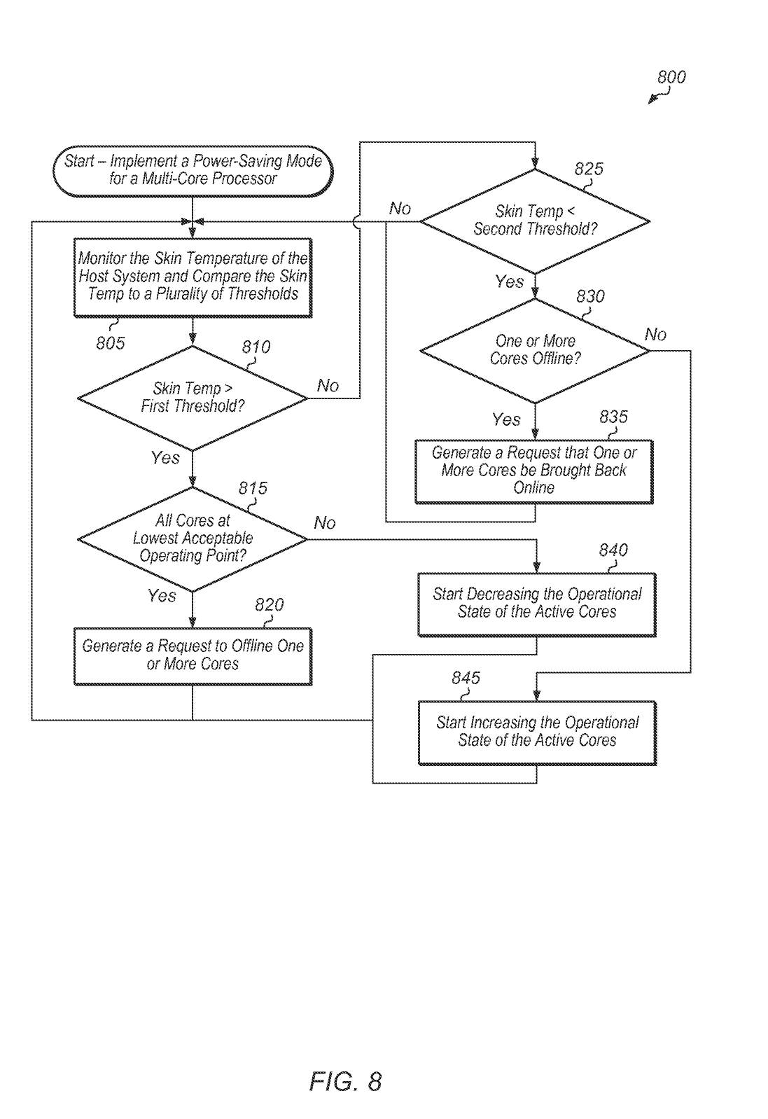

Turning now to FIG. 8, another embodiment of a method 800 for implementing a power-saving mode for a multi-core processor is shown. For purposes of discussion, the steps in this embodiment are shown in sequential order. It should be noted that in various embodiments of the method described below, one or more of the elements described may be performed concurrently, in a different order than shown, or may be omitted entirely. Other additional elements may also be performed as desired. Any of the various devices, apparatuses, or systems described herein may be configured to implement method 800.

The power management unit of a multi-core processor may monitor the skin temperature (temp) of the host system or device and compare the skin temperature to a plurality of thresholds (block 805). Generally speaking, “skin temperature” refers to the temperature of the surface of a device. For example, on a tablet type device the skin temperature may refer to the temperature of the glass on the LCD screen, or that of the back chassis which may be metal or plastic. While the following discussion describes embodiments related to a skin temperature of a device, the methods and mechanisms described herein may utilize a temperature other than a skin or surface of a device. For example, one or more thermal sensors may be located within a device to provide a temperature reading that differs from that of the surface (or skin) of the device. Numerous such embodiments are possible and are contemplated. Depending on the embodiment, the multi-core processor may be a CPU, GPU, or other type of processor. If the skin temperature of a multi-core processor is above a first threshold (conditional block 810, “yes” leg), then the power management unit may determine if all of the cores of the multi-core processor are operating at the lowest acceptable operational point (conditional block 815). If all of the cores of the multi-core processor are operating at the lowest acceptable operational point (conditional block 815, “yes” leg), then the power management unit may generate a request for one or more cores to be powered down (block 820). For example, in one embodiment, if the processor has four cores, the power management unit may generate a request to power down two cores in block 815. In other embodiments, the processor may have other numbers of cores and/or the power management unit may request for other numbers of cores to be powered down. After block 820, method 800 may return to block 805 with the power management unit continuing to monitor the skin temperature of the multi-core processor. If any of the cores of the multi-core processor are operating at an operating point above the lowest acceptable operational point (conditional block 815, “no” leg), then the power management unit may start decreasing the operational state of the active cores (block 840).

If the skin temperature of the multi-core processor is below the first threshold (conditional block 810, “no” leg), then the power management unit may determine if the skin temperature is below a second threshold (conditional block 825). It may be assumed for the purposes of this discussion that the second threshold is less than the first threshold. If the skin temperature is below the second threshold (conditional block 825, “yes” leg), then the power management unit may determine if there are one or more cores that are currently offline (conditional block 830). If there are one or more cores that are currently offline (conditional block 830, “yes” leg), then the power management unit may generate a request that one or more cores be brought back online (block 835). After block 835, method 800 may return to block 805 with the power management unit continuing to monitor the skin temperature of the multi-core processor. If all of the cores are currently online (conditional block 830, “no” leg), then the power management unit may start increasing the operational state of the active cores (block 845). After block 845, method 800 may return to block 805 with the power management unit continuing to monitor the skin temperature of the multi-core processor. If the skin temperature is above the second threshold (conditional block 825, “no” leg), then method 800 may return to block 805 with the power management unit continuing to monitor the skin temperature of the multi-core processor.

In various embodiments, program instructions of a software application may be used to implement the methods and/or mechanisms previously described. The program instructions may describe the behavior of hardware in a high-level programming language, such as C. Alternatively, a hardware design language (HDL) may be used, such as Verilog. The program instructions may be stored on a non-transitory computer readable storage medium. Numerous types of storage media are available. The storage medium may be accessible by a computing system during use to provide the program instructions and accompanying data to the computing system for program execution. The computing system may include at least one or more memories and one or more processors configured to execute program instructions.

It should be emphasized that the above-described embodiments are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. A method comprising:
initiating power down of a compute unit;
determining a value of a wakeup timer based at least in part on a history of activity of the compute unit;
starting the wakeup timer; and
powering down the compute unit until the wakeup timer expires.

2. The method as recited in claim 1, further comprising:
setting the wakeup timer to a first value responsive to determining an activity indicator is less than a first threshold; and
setting the wakeup timer to a second value responsive to determining the activity indicator is greater than the first threshold, wherein the second value is less than the first value.

3. The method as recited in claim 2, wherein the activity indicator is a counter and the method further comprises incrementing the counter responsive to detecting a memory access by the compute unit during a given interval.

4. The method as recited in claim 3, further comprising decrementing the counter responsive to detecting no memory accesses by the compute unit during the given interval.

5. The method as recited in claim 1, wherein the compute unit is a first core of a multi-core processor, and wherein the method further comprises:
calculating an average number of active cores for the multi-core processor;
calculating an average core utilization of the multi-core processor; and
generating a request to power down the first core responsive to determining the average number of active cores is less than a first threshold and the average core utilization is less than a second threshold.

6. The method as recited in claim 5, further comprising powering up a second core responsive to determining the average core utilization is above a third threshold.

7. The method as recited in claim 1, wherein the compute unit is a first core of a multi-core processor, and wherein the method further comprises:
monitoring a temperature of the multi-core processor;
generating a request to power down the first core responsive to determining the temperature is above a threshold and all cores of the multi-core are operating at a lowest acceptable operating point.

8. A system comprising:
a memory;
a compute unit coupled to the memory;
a power management unit coupled to the compute unit, wherein the power management unit is configured to:
determine a value of a wakeup timer based at least in part on a history of activity of the compute unit;
start the wakeup timer; and
power down the compute unit until the wakeup timer expires.

9. The system as recited in claim 8, wherein the power management unit is further configured to:
set the wakeup timer to a first value responsive to determining an activity indicator is less than a first threshold; and
set the wakeup timer to a second value responsive to determining the activity indicator is greater than the first threshold, wherein the second value is less than the first value.

10. The system as recited in claim 9, wherein the activity indicator is a counter and the power management unit is further configured to increment the counter responsive to detecting a memory or input/output (I/O) access by the compute unit during a given interval.

11. The system as recited in claim 10, wherein the power management unit is further configured to decrement the counter responsive to detecting no memory or I/O accesses by the compute unit during the given interval.

12. The system as recited in claim 8, wherein the compute unit is a first core of a multi-core processor, and wherein the power management unit is configured to:
calculate an average number of active cores for the multi-core processor;
calculate an average core utilization of the multi-core processor; and
generate a request to power down the first core responsive to determining the average number of active cores is less than a first threshold and the average core utilization is less than a second threshold.

13. The system as recited in claim 12, wherein the power management unit is further configured to power up a second core responsive to determining the average core utilization is above a third threshold.

14. The system as recited in claim 8, wherein the compute unit is a first core of a multi-core processor, and wherein the power management unit is configured to:
monitor a temperature of the multi-core processor; and
generate a request to power down the first core responsive to determining the temperature is above a threshold and all cores of the multi-core are operating at a lowest acceptable operating point.

15. A non-transitory computer readable storage medium storing program instructions, wherein the program instructions are executable by a processor to:
initiate power down of a compute unit;
determine a value of a wakeup timer based at least in part on a history of activity of the compute unit;
start the wakeup timer; and
power down the compute unit until the wakeup timer expires.

16. The non-transitory computer readable storage medium as recited in claim 15, wherein the program instructions are further executable by a processor to:
set a wakeup timer to a first value responsive to determining an activity indicator is less than a first threshold; and
set the wakeup timer to a second value responsive to determining the activity indicator is greater than the first threshold, wherein the second value is less than the first value.

17. The non-transitory computer readable storage medium as recited in claim 16, wherein the activity indicator is a counter, wherein the program instructions are further executable by a processor to increment the counter responsive to detecting a memory access by the compute unit during a given interval.

18. The non-transitory computer readable storage medium as recited in claim 17, wherein the program instructions are further executable by a processor to decrementing the counter responsive to detecting no memory accesses by the compute unit during the given interval.

19. The non-transitory computer readable storage medium as recited in claim 15, wherein the compute unit is a first core of a multi-core processor, wherein prior to initiating power down of the first core, the program instructions are executable by a processor to:
calculate an average number of active cores for the multi-core processor;
calculate an average core utilization of the multi-core processor; and
generate a request to power down the first core responsive to determining the average number of active cores is less than a first threshold and the average core utilization is less than a second threshold.

20. The non-transitory computer readable storage medium as recited in claim 19, wherein the program instructions are further executable by a processor to power up a second core responsive to determining the average core utilization is above a third threshold.
